(19) United States
(12) Patent Application Publication
(10) Pub. No.: US 2022/0381522 A1
(43) Pub. Date: Dec. 1, 2022

(54) LIQUID CIRCULATION HEAT EXCHANGER AND CONNECTOR FOR SUCH AN EXCHANGER

(71) Applicant: Valeo Systemes Thermiques, Le Mesnil Saint-Denis (FR)

(72) Inventors: Lionel Robillon, La Suze Sur Sarthe (FR); Frédéric Tison, La Suze Sur Sarthe (FR); Fabienne Tourneux, La Suze Sur Sarthe (FR); Véronique Westermann, Reims (FR); Vincent Joubier, Le Mesnil Saint Denis Cedex (FR)

(73) Assignee: Valeo Systemes Thermiques, Le Mesnil Saint-Denis (FR)

(21) Appl. No.: 17/596,694

(22) PCT Filed: Jun. 16, 2020
(86) PCT No.: PCT/FR2020/051038

§ 371 Date: Aug. 10, 2022

(30) Foreign Application Priority Data
Jun. 18, 2019 (FR) FR1906506

(51) Int. Cl. F28F 9/02; F28D 1/03

(52) U.S. Cl. CPC F28F 9/0248; F28D 1/035; F28D 2021/0028

(57) ABSTRACT

The invention relates to a heat exchanger provided with a base plate (10, 10′) and a liquid circulation space (15) formed between a plate (20, 20′) attached on the base plate and the base plate, the exchanger comprising at least one fluid connector (30, 31, 32), fixed on the base plate or on a return (12) inclined with respect to the base plate (10′) and connected to an inlet or outlet channel (21, 22) of the liquid circulation space, said connector comprising a tubular nozzle (33, 34, 35), for connecting the device to a tubing of an external fluid circuit, a base (36, 37) provided with a recess (38, 39) into which the tubular nozzle opens and with a mouth (38a, 39a) for connection to the channel, the recess forming a fluid passage between the mouth (38a, 39a) and the nozzle (33, 34, 35), for which the recess has an opening on a fixing face (40, 40′) of the connector on the base plate or on the return, the base plate or the return forming a closure wall of the recess of the base providing the sealing of the fluid passage.

### TECHNICAL FIELD

The present application is in the field of the production of heat exchangers in particular for battery modules and in particular motor vehicle battery modules, and relates to a liquid circulation heat exchanger and a fluidic connector for such an exchanger.

The invention is applicable in particular to all electric or hybrid motor vehicles with a battery pack or battery cells.

A rapid-charging phase of the electrical storage device or battery cells, which consists in charging the electrical storage device at high voltage and amperage, so as to charge the electrical storage device in a maximum time of a few tens of minutes. This rapid charge causes heating of the electrical storage device, which needs to be cooled.

During the rapid charge, the power released by the battery is very high, and this is the key design aspect for the system. In order to extract this thermal power, which is usually between 10 and 20 kW, it is necessary to increase the surface areas for exchanges between a heat-transfer fluid and the electric cells.

To this end, first exchangers are disposed on the casings of battery packs and these exchangers are connected to a fluidic circuit provided with one or more second exchangers that dissipate the heat into the atmosphere. The connection of the exchangers may be bulky and reduces the storage space.

### PRIOR ART

Battery modules generally have a frame in which the individual battery cells are disposed, and it is known practice to cool battery modules by means of heat exchanger plates or heat exchangers, having panels which are disposed on the frame and in which a coolant circulates. The heat exchangers are generally made using two pressed plates which are joined together in a sealed manner and in which meanders or a liquid circulation space are formed. In this context, it is known practice to equip the panels with connecting end fittings which are crimped or welded to or are in the continuation of the panels and which protrude beyond the panels in order to connect them to the external coolant circuit.

The document DE102017202552 provides examples of heat exchangers having pressed plates and associated fluidic connection end fittings.

However, such end fittings are bulky and, since the exchanger panels are generally fairly thin, the space around the battery modules is limited and the sealing of such connections should be ensured, a more compact solution is desired.

Furthermore, in the field of exchanger and battery system assemblies, the application FR18 52650 in the name of the applicant describes heat exchangers made in the form of cooling plates provided with a flat plate and a pressed plate forming a fluid passage space, provided with irregularities to disrupt the flow of the fluid within the exchanger. The connection of the exchangers to an external fluidic circuit is made with end fittings welded to the pressed plates, which are perforated to receive the end fittings.

That document describes in particular the possibility of having such exchangers directly in contact with at least one region of one or more battery cells when an electrical energy storage module is placed in a receiving housing. In that case, the module does not have a casing for the battery cells.

Such a solution makes it possible to reduce the volume taken up by the electrical energy storage module.

### SUMMARY

The present application improves the heat exchanger devices by proposing a device that is capable of being mounted directly in contact with battery cells or on a battery cell pack and wherein the space taken up by the fluidic connections of the heat exchanger is reduced in order to further reduce the dimensions of an energy storage module. To this end, the device of the present application provides more particularly a heat exchanger provided with a base plate and a liquid circulation space formed between a plate attached to the base plate and the base plate, which has at least one fluidic connector fixed to the base plate or to a lip that is inclined with respect to the base plate and connected to an inlet or outlet channel of the liquid circulation space, said connector having a tubular end fitting for connecting the device to a pipe of an external fluidic circuit, a mount provided with a recess into which the tubular end fitting opens and with a mouth for connecting to said channel, the recess forming a fluid passage between the mouth and the end fitting, wherein the recess has an opening on a face for fastening the connector to the base plate or to said lip, the base plate or said lip forming a wall for closing said recess in the mount, ensuring that said fluid passage is sealed.

This design reduces the bulk of the fluidic connector and positions it as close as possible to the assembly formed by the base plate and the attached plate.

The attached plate, which may be a pressed plate, may in particular be a plate welded, adhesively bonded or joined by brazing to the base plate.

The attached plate may in particular be provided with meanders forming said liquid circulation space.

According to a first embodiment, the mouth of the mount of the connector is made in the continuation of the opening of said fastening face and, with one end of the channel in the attached plate opening out at the edge of the base plate, the connector is fastened in an overhanging manner to the inclined lip such that the mount of the connector protrudes beyond the lip in order to align the mouth of the mount with the end of the channel. In this embodiment in which the base plate has an inclined lip, the fluidic connector advantageously does not protrude in a direction perpendicular to the upper plane of the attached plate.

The base plate and the inclined lip may be two intersecting faces of one and the same profiled element.

In this case, the profiled element may make up all or part of a casing receiving battery cells.

According to a second embodiment, the fastening face of the mount of the connector is received on the base plate, the mouth of the mount extends over a face of the mount perpendicular to the fastening face of the mount in communication with one end of the channel in the attached plate.

In this case, the connector may be positioned directly on the base plate in line with the outlet or inlet channel of the circulation space.

In order to center the connector with respect to the channel during the assembly of the exchanger, the fluidic connector has at least one means for centering the mouth with respect to said channel.

Preferably, said means consists of a pin, rod or tab that is inserted into the channel, and preferably consists of two pins or rods that are disposed on either side of the mouth and fit in the channel.

The fluidic connector may be welded or adhesively bonded in position on the base plate and on the end of the channel in the attached plate. This makes it possible to produce the exchanger directly in a welding or adhesive bonding operation of the assembly made up of the base plate, attached plate and inlet/outlet connectors.

The present application also relates to a one-piece fluidic connector for a heat exchanger, which is made by machining or molding and has a mount provided with a recess and a tubular end fitting opening into the recess, which constitutes a fluidic passage between a mouth of the mount and a channel in the tubular end fitting, and wherein the mount has a fastening face provided with an opening creating the recess.

Such a connector is easy to manufacture both by molding and by machining in different sizes.

According to a first embodiment, with the connector being designed to be fastened to a lip inclined with respect to the base plate, the mouth is produced from a continuation of the opening in the plane of the opening, the surround of the mouth having walls provided with rounded portions for bearing on a curved edge between the inclined lip and the base plate.

According to a second embodiment, the connector is designed to be fastened to the base plate and the mouth is formed from a continuation of the opening in a plane perpendicular to the opening.

### BRIEF DESCRIPTION OF THE DRAWINGS

Further features, details and advantages will become apparent on reading the following detailed description and from studying the appended drawings, in which:

FIG. 1 shows a perspective view of a first example of a part of the base plate, of the attached plate and of the connector, which are joined together;

FIG. 2 shows an exploded perspective bottom view of the elements in FIG. 1;

FIG. 3 shows a perspective bottom view of the connector in FIG. 1;

FIG. 4 shows a perspective view of a second example of a part of the base plate, of the attached plate and of the connector, which are joined together;

FIG. 5 shows an exploded perspective bottom view of the base plate, of the attached plate and of an embodiment variant of the connector in FIG. 4;

FIG. 6 shows a rear three-quarter perspective view of the connector in FIG. 5.

### DESCRIPTION OF THE EMBODIMENTS

The drawings and the description below contain, for the most part, elements of a certain character. Therefore, they may not only serve for understanding the present disclosure better, but also contribute to its definition, where appropriate.

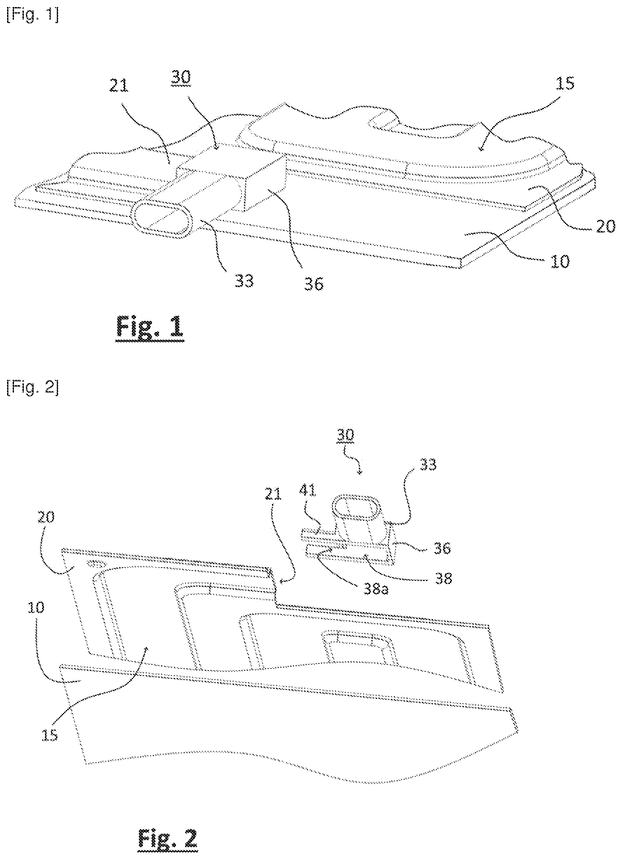

According to the examples in FIGS. 1 and 4, the present application provides in particular a heat exchanger provided with a base plate 10, 10′ and with a liquid circulation space 15 formed between the base plate and a plate 20, 20′ attached to the base plate.

According to the example, the attached plate has inlet and outlet channels 21, 22, 23 which arrange meanders 15 for the circulation of a heat-transfer fluid between the attached plate and the base plate. The ends of the channels exit the attached plate either, as shown in FIG. 2, at a cutout in the attached plate that forms a space in the base plate, or at a peripheral edge of the attached plate and of the base plate, as shown in FIG. 4.

In a similar manner to the application FR18 52650, the inlet and outlet channels can arrange a space under the base plate provided with internal bosses for dispersing a flow of the heat-transfer fluid rather than meanders.

The heat exchanger has an inlet fluidic connector and an outlet fluidic connector, which can take up two configurations that will be described below.

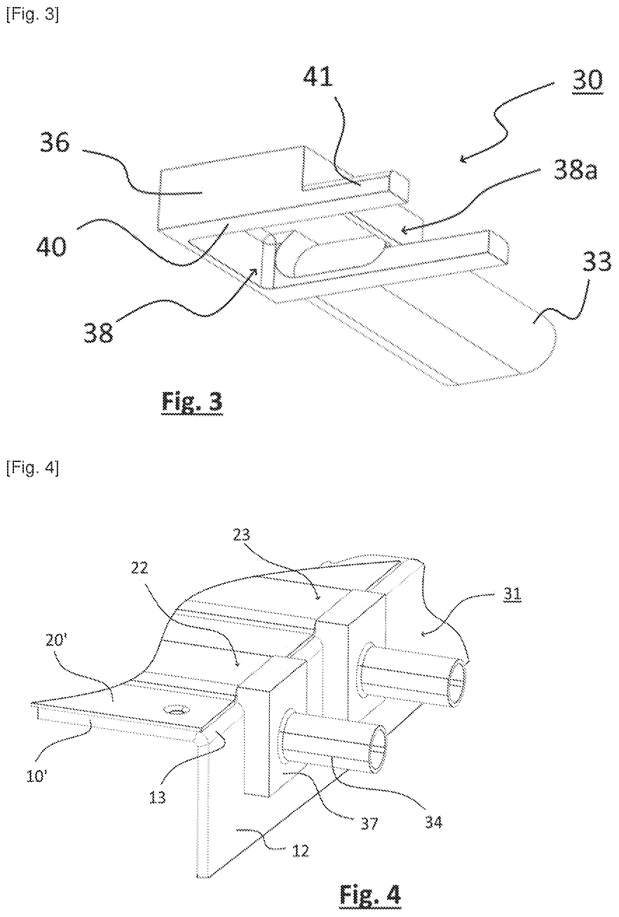

In the example in FIGS. 1 to 3, the fluidic connector 30, shown in detail more particularly in FIG. 3, has a mount 36 continuing the outlet of the channel and a tubular end fitting 33 extending parallel to the attached plate.

According to the example shown, the tubular end fitting 33, which constitutes an outlet or inlet tube for heat-transfer fluid for the heat exchanger, is oval so as to reduce the height of the connector. An end fitting in the form of a cylinder of revolution may also be envisioned in this embodiment, however. This end fitting will make it possible to connect the exchanger to a pipe of an external fluid circuit connected for example to a radiator in contact with the air outside the vehicle and optionally provided with a cooling fan.

The mount constitutes a passage for liquid between a mouth 38a of the connector and the tubular end fitting. However, this passage is not closed at the connector, this passage being formed by a recess 38 that starts from an opening in one face 40 of the mount of the connector. In this way, it is easier to manufacture the connector and, on account of the lack of a closing wall of the passage, its dimensions are smaller.

Furthermore, the face 40 is a face for fastening the connector to a wall which is the base plate 10 in the case of the assembly in FIG. 1. The base plate will thus seal the passage formed by the recess 38.

Still in this example and returning to FIG. 3, the mouth 38a is formed from a continuation of the opening in the wall 40 in a plane perpendicular to this opening.

According to FIG. 2 in particular, the attached plate 20 and the connector 30 are joined together on the base plate 10, the connector having pins or rods 41 that are introduced into the opening of the channel 21 in order that the mouth 38a of the mount is positioned correctly next to the inlet or the outlet of the channel.

Once this assembly has been made, the connector and the attached plate are welded, for example by laser welding, or adhesively bonded to the base plate.

The base plate, the attached plate and the connector may be metallic, in particular made of aluminum or steel, but also made of filled polymer or of ceramic depending on the heat exchange performance obtained with these materials.

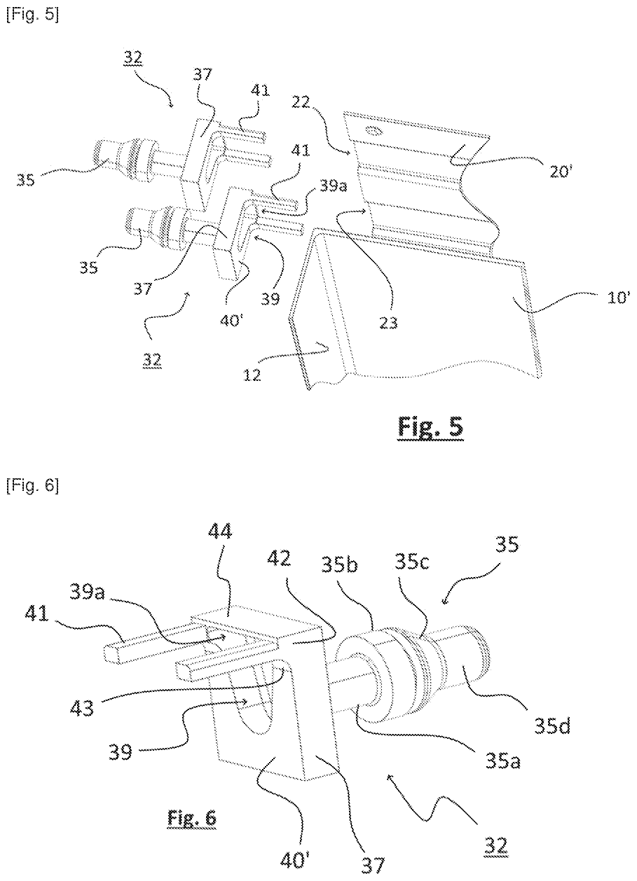

In the example in FIGS. 4 and 5, the base plate 10′ has a lip 12 that is inclined with respect to the base plate. The base plate and the inclined lip may be two walls of a bracket or of any other type of profiled element optionally at 90° to one another.

In this case, the connector 31 may be fastened to the lip 12 and connected to an inlet or outlet channel 21, 22 of the liquid circulation space located at the edge of the base plate.

The connector 31 also has a tubular end fitting such as a straight end fitting 34 in FIG. 4 or an end fitting 35 provided with a profile 35a, 35b, 35c, 35d ensuring correct fastening and sealing for a hose connected to the connector as shown in FIGS. 5 and 6.

As shown more particularly in FIG. 6, the connector also has a mount 37 provided with a recess 39, into which the tubular end fitting opens, and with a mouth 39a for connecting to said channel.

Here too, the recess forms a fluid passage between the mouth 39a and the end fitting 34, 35; however, in this embodiment, the mouth is in a plane parallel to the opening of the recess and not in a plane perpendicular to this opening. It will be obvious to a person skilled in the art that, in an embodiment in which the lip forms a non-flat angle other than 90° with the base plate, the mouth could also extend in a plane that intersects, non-perpendicularly, the opening of the recess.

In this way, with the fastening face 40′ of the connector being pressed against the lip 12, the mouth 39a is vertically above this lip so as to be positioned next to the inlet or the outlet of a channel in the attached plate.

Here, it is the lip which forms a wall closing the recess in the mount and which seals the fluid passage between the mouth and the end fitting. In order to connect the mouth to the channel in the attached plate, the connector is fastened in an overhanging manner to the inclined lip 12 such that the mount of the connector protrudes beyond the inclined lip in order to align the mouth 39a of the mount with the end of the channel 22, 23 in the attached plate that opens out at the edge of the base plate 10′.

In the example shown, the lip makes an angle of 90° with the base plate and the mouth and the end of the channel are perpendicular to the base plate. In the case in which the lip does not make an angle of 90° with the base plate, the cutout of the end of the channel can be made in a plane parallel to the lip in order to be applied to the mouth.

The fluidic connector shown thus has, on either side of the mouth, pins or rods 41 for centering the mouth with respect to said channel. It is possible, however, to position a single pin or a tab in order to position the fluidic connector with respect to the channel.

Moreover, this connector has, at a surround 42, 44 of the mouth, lateral walls 42 provided with rounded portions 43 intended to hug the curvature 13 of the edge between the inclined lip 12 and the base plate 10′ and an upper wall 44 that meets the end of the attached plate above this curvature.

The fluidic connector 31, 32 is welded or adhesively bonded in position on the base plate, the lip and on the end of the channel in the attached plate at the same time as the attached plate, the assembly being done as shown in FIG. 5 with the rods 41 of the connector introduced into the ends of the channels 22, 23.

The various variants of fluidic connectors 30, 31, 32 are each made from one single piece by machining or molding and have a mount 36, 37 provided with a recess 38, 39, the fastening face 40, 40′ of which is provided with an opening creating the recess connecting the mouth of the mount and the tube of the end fitting.

Advantages of the embodiments of the device of the present application are:

In the example in FIGS. 1 to 3, the fluidic connector does not protrude from the lateral bulk of the battery module and adds little extra thickness with respect to the attached plate.

In the example in FIGS. 4 to 6, the fluidic connector does not add any extra thickness with respect to the attached plate which contains the circulation space for the heat-transfer fluid.

In both cases, the lack of a closing wall at the connector reduces its thickness.

The sealing of a part of the fluidic connector is effected with the base plate, making it possible to produce a part to be machined without an angular member or deformation.

Since the offset of the connection with the external fluidic circuit is made in the continuity of a channel in the attached plate, it is not necessary to provide a hole in the attached plate and the connection between the fluidic connector and the attached plate is created by simple pressing of the attached plate.

The creation of the fluidic connector which is applied to the base plate or its lip makes it possible to use a laser welding process to seal the base plate/attached plate/connector assembly in a single operation.

The exchanger is compact and easy to connect.

The invention is not limited to the examples shown and for example the two types of connectors and of mounting can coexist in one and the same exchanger, providing a great deal of flexibility for the installation of the inlets/outlets of the exchangers. Moreover, the outlet of the end fittings of the connectors in FIG. 6 can be realized on a different face of the mount, for example the bottom face according to FIG. 6.

1. A heat exchanger provided with a base plate and a liquid circulation space formed between a plate attached to the base plate and the base plate, comprising:
at least one fluidic connector fixed to the base plate or to a lip that is inclined with respect to the base plate and connected to an inlet or outlet channel of the liquid circulation space,
said connector having a tubular end fitting for connecting the device to a pipe of an external fluidic circuit;
a mount provided with a recess into which the tubular end fitting opens and with a mouth for connecting to said channel, the recess forming a fluid passage between the mouth and the end fitting,
wherein the recess has an opening on a face for fastening the connector to the base plate or to said lip, the base plate or said lip forming a wall for closing said recess in the mount, ensuring that the fluid passage is sealed.

2. The heat exchanger as claimed in claim 1, wherein the attached plate is a plate welded or adhesively bonded to the base plate and provided with meanders forming said liquid circulation space.

3. The heat exchanger as claimed in claim 1, wherein the mouth of the mount of the connector is made in the continuation of the opening of said fastening face and wherein, with one end of the channel in the attached plate opening out at the edge of the base plate, the connector is fastened in an overhanging manner to the lip inclined with respect to the base plate, such that the mount of the connector protrudes beyond said lip in order to align the mouth of the mount with the end of the channel.

4. The heat exchanger as claimed in claim 3, wherein the base plate and the inclined lip are two intersecting faces of one and the same profiled element.

5. The heat exchanger as claimed in claim 1, wherein the fastening face of the mount of the connector is received on the base plate, the mouth of the mount in communication with one end of the channel in the attached plate extending over a face of the mount perpendicular to the fastening face of the mount.

6. The heat exchanger as claimed in claim 1, wherein the fluidic connector has at least one means for centering the mouth with respect to said channel.

7. The heat exchanger as claimed in claim 1, wherein the fluidic connector is welded, adhesively bonded or joined by brazing in position on the base plate and/or the extension and on the end of the channel in the attached plate.

8. A one-piece fluidic connector for a heat exchanger as claimed in claim 1, wherein the one-piece fluidic connector is made by machining or molding and has a mount provided with a recess and a tubular end fitting opening into the recess, which constitutes a fluidic passage between a mouth of the mount and a channel in the tubular end fitting, and wherein the mount has a fastening face provided with an opening creating the recess.

9. The fluidic connector as claimed in claim 8, wherein, with the connector being designed to be fastened to a lip inclined with respect to the base plate, the mouth is produced from a continuation of the opening in the plane of the opening, the surround of the mouth having walls provided with rounded portions for bearing on a curved edge between the inclined lip and the base plate.

10. The fluidic connector as claimed in claim 8, wherein, with the connector being designed to be fastened to the base plate, the mouth is formed from a continuation of the opening in a plane perpendicular to the opening.
